(19) United States
(12) Patent Application Publication
(10) Pub. No.: US 2026/0349121 A1
(43) Pub. Date: Nov. 5, 2026

(54) MONITORING SUBSEA EQUIPMENT THROUGH MUON IMAGING

(71) Applicant: Chevron U.S.A. Inc., San Ramon, CA (US)

(72) Inventor: Kevin John Jakubenas, Katy, TX (US)

(21) Appl. No.: 19/196,022

(22) Filed: May 1, 2025

(51) Int. Cl. G01T 1/20; E21B 47/001; G01T 1/208; G01T 1/29

(52) U.S. Cl. CPC G01T 1/20188; E21B 47/001; G01T 1/208; G01T 1/2992

(57) ABSTRACT

A system includes: a subsea equipment component positioned in a subsea environment; a first muon detector positioned subsea at a location adjacent the subsea equipment component in a position such that muons will pass through the first muon detector after passing through the subsea equipment component, wherein the first muon detector includes at least one detector panel and is configured to output electrical signals indicative of muon intensity in response to muons interacting with the at least one detector panel; and a data processing system configured to receive data indicative of the electrical signals output from the first muon detector and generate an image of the subsea equipment component based on the received data.

### FIELD OF THE INVENTION

The present disclosure is directed generally to monitoring subsea equipment and, more particularly, to methods for monitoring subsea equipment using muon imaging.

### BACKGROUND

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

In the production of fluids from a subsea hydrocarbon reservoir, a variety of subsea equipment are typically used. Such subsea equipment can include subsea conduits (e.g., pipelines, flowlines, jumpers, risers, etc.) subsea storage, actuation, or control equipment (e.g., tanks, pumps, motors, etc.), and other subsea structures (e.g., mooring lines). This subsea equipment is located and operated in the water, sometimes at great depths, for long periods of time.

Monitoring subsea equipment can be important to achieving successful and optimal production from subsea wells, assessing the ongoing integrity of equipment (thereby facilitating planned preventative measures and avoiding unplanned interventions), and maximizing the useful life of the equipment. Monitoring subsea equipment can include, for example, monitoring internal conditions of the subsea equipment (e.g., material deposition in flow equipment, corrosion/erosion inside the equipment, stuck valves, etc.) or monitoring external conditions of the subsea equipment (e.g., external corrosion/erosion, marine growth, equipment movement, etc.).

One conventional method for monitoring subsea equipment includes performing periodic visual inspections of the equipment using a remotely operated vehicle (ROV) that can travel underwater and gather information with a camera. However, some external portions of subsea equipment can be difficult to access visually with an ROV due to the dimensions and/or arrangement of the equipment. In addition, an ROV cannot provide a visualization of internal portions of the subsea equipment. Computed tomographic (CT) imaging has been used to detect deposits inside subsea pipelines. However, CT devices are normally transported to a location where deposition is suspected, and images of pipeline cross-sections are created by moving the CT device from one location to another. This is a time intensive and costly process.

A continued need exists for improved techniques for monitoring subsea equipment. Additionally, techniques that would allow for monitoring subsea equipment continuously over a period of time would be useful. Such techniques could identify areas of unexpectedly rapid change in the subsea equipment so that they can be addressed at the correct time (not too late, not too early). Additionally, such techniques could provide a more accurate assessment of the subsea equipment, potentially extending the service lifetime of subsea equipment components.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In accordance with aspects of the disclosure, a system includes: a subsea equipment component positioned in a subsea environment; a first muon detector positioned subsea at a location adjacent the subsea equipment component in a position such that muons will pass through the first muon detector after passing through the subsea equipment component, wherein the first muon detector includes at least one detector panel and is configured to output electrical signals indicative of muon intensity in response to muons interacting with the at least one detector panel; and a data processing system configured to receive data indicative of the electrical signals output from the first muon detector and generate an image of the subsea equipment component based on the received data.

In accordance with other aspects of the disclosure, a method includes: using a first muon detector, positioned at a subsea location adjacent to a subsea equipment component in a position such that muons will pass through the first muon detector after passing through the subsea equipment component, to detect muons incident on at least one detector panel of the first muon detector; outputting electrical signals indicative of muon intensity from the first muon detector; receiving data indicative of the electrical signals output from the first muon detector at a data processing system; and generating, via the data processing system, an image of the subsea equipment component based on the received data.

In accordance with other aspects of the disclosure, a subsea muon detection clamp system includes: a clamp frame structure; a handle coupled to the clamp frame structure and configured to be engaged by a remote operated vehicle (ROV) or autonomous underwater vehicle (AUV) for selective placement of the clamp system relative to a subsea equipment component at a subsea location; and a first muon detector positioned on a first surface of the clamp frame structure configured to be placed substantially beneath the subsea equipment component, wherein the first muon detector includes at least one detector panel and is configured to output electrical signals indicative of muon intensity in response to muons interacting with the at least one detector panel.

### BRIEF DESCRIPTION OF DRAWINGS

The drawings illustrate only example embodiments and are therefore not to be considered limiting in scope, as the example embodiments may admit to other equally effective embodiments. The elements and features shown in the drawings are not necessarily to scale, emphasis instead being placed upon clearly illustrating the principles of the example embodiments. Additionally, certain dimensions or positions may be exaggerated to help visually convey such principles. In the drawings, reference numerals designate like or corresponding, but not necessarily identical, elements.

FIG. 1 is a schematic illustration of an example system for monitoring subsea equipment using subsea muon radiography, in accordance with one or more aspects of the present disclosure.

FIG. 2 is a schematic illustration of an example system for monitoring subsea equipment using subsea muon tomography, in accordance with one or more aspects of the present disclosure.

FIG. 3 is a schematic illustration of another example system for monitoring subsea equipment using subsea muon tomography, in accordance with one or more aspects of the present disclosure.

FIGS. 4A and 4B are schematic block diagrams illustrating example components of a muon imaging assembly for use in any of the systems of FIGS. 1-3, in accordance with one or more aspects of the present disclosure.

FIGS. 5A and 5B are schematic illustrations of example arrangements of subsea muon detector(s), in accordance with one or more aspects of the present disclosure.

FIG. 6 is a schematic illustration of an example arrangement of muon detector(s) used for imaging a subsea conduit, in accordance with one or more aspects of the present disclosure.

FIG. 7 is a schematic illustration of an example system for monitoring an underground pipeline using underground muon imaging, in accordance with one or more aspects of the present disclosure.

### DETAILED DESCRIPTION OF THE INVENTION

The present disclosure is directed to systems and methods for using naturally occurring muons to image subsea equipment. Muon imaging has been used in the past for surface imaging of volcanoes, archeological areas, and trucks passing through a portal, among other uses. However, muon imaging has not previously been used for subsea equipment imaging. The disclosed systems and methods have two muon imaging applications: 1) muon radiography (generating 2D images) and 2) muon tomography (generating 3D images).

Muons are high energy particles created by the collision of cosmic rays with atoms in Earth's atmosphere. Muons are generated when highly energetic cosmic rays from the sun hit the upper atmosphere and break down from a proton to a neutron. Naturally occurring muons have such high energy that they can penetrate not only the air, but also miles of rock and water. Muons travel close to the speed of light and have a long, but limited penetration depth. For example, muons can penetrate roughly 5 kilometers of sea water before the signal drops. The inventor recognized that muon imaging could be used for subsea equipment imaging, since muons can travel through kilometers of sea water.

Since muons are naturally occurring radiation, they can permit non-destructive imaging, like an x-ray but without the need for a radiation source. Only a well-positioned muon detector is needed. Since the muons are charged, they break apart as they interact with materials through which they travel. Muon detectors work by detecting the charge and location of incidence of any muon that hits the detector.

Muon radiography and tomography has been developed for imaging large above ground structures (such as pyramids, nuclear reactors, or spent nuclear fuel storage casks) and vehicles at border crossings. However, using muons for imaging has certain drawbacks: 1) the object to be imaged needs to be positioned between the detector and the sky, 2) the flux of muons is relatively small, so data collection requires a relatively long time (minutes to days), and 3) contrast in images requires a large contrast in atomic number and density (e.g., heavy, dense elements absorb some energy from muons, light gaseous elements almost none).

The inventor recognized that the drawbacks associated with muon imaging would not be significant when applied to imaging subsea equipment. For example, subsea equipment is largely fixed in place, so the data collection can take place over a long period of time. There is also a large contrast in atomic number and density between seawater (and fluids/gaps inside subsea equipment) and the subsea equipment itself.

For subsea oil and gas equipment, inspections are handled differently from on-land equipment inspections, since the subsea equipment is continuously operated. There is no easy way to access the interior of subsea equipment to check for wear, obstruction, and/or corrosion throughout the operational life of the equipment. Although CT equipment can be sent subsea and used to take periodic measurements, this process can be costly and time consuming. Muon imaging of subsea equipment may allow for tracking the effects of wear and/or corrosion over time in subsea equipment such as pumps, pipelines, valves, or other equipment in a more consistent and lower cost manner than using periodically deployed CT equipment. Monitoring these effects on subsea equipment through muon imaging can guide operation and maintenance decisions over the life of the equipment.

Muon imaging systems can be incorporated into the initial deployment of the subsea equipment being imaged. For example, when building the subsea equipment, one or more muon detectors can be placed appropriately with respect to the subsea equipment and/or deployed in an integrated system with the subsea equipment. Certain types of muon detectors may be desired for subsea use. For example, the muon detector(s) used may include scintillator type muon detectors or gas ionization type detectors. These types of detectors may be more easily adapted to subsea use as they convert their signals into electronic form that can be stored digitally. The size of muon detector(s) that may be used depends on the size of the subsea equipment being imaged. For example, the muon detector(s) may be approximately the same size as the subsea equipment to be imaged, since the detector is stationary and there is no way to direct the naturally occurring muon beams.

As discussed above, muon imaging of subsea equipment can be used to show changes in the subsea equipment, such as corrosion or erosion, over time. Muon-based image quality is determined by a combination of the seawater depth (muon flux reduces with seawater depth and depths beyond 5 kilometers may have insufficient muon flux for imaging), acquisition time (muon images will become sharper the longer the acquisition time, but the time is on the order of hours to days to weeks for a high quality image), and, for tomography, how accurately the two muon detectors'relative positions are known (muons move close to the speed of light, so the relative position of the two sensors needs to be known at very close to the same time to prevent degraded resolution).

Since naturally occurring muons only provide about 1 muon per square centimeter per minute on a detector, muon imaging of subsea equipment is not suitable for monitoring equipment that moves (e.g., a valve opening and closing), since image blurring can occur with even slow movements. However, for fixed subsea equipment with high element and density contrast, muon radiography/tomography can produce detailed images over weeks using almost no power. Furthermore, increasing the time over which individual muon images are obtained can provide higher resolutions of those images. Monitoring muon-based images of subsea equipment over a period of years can provide information regarding corrosion, erosion, marine growth, stuck valves, etc. Example use cases for the application of muon imaging to subsea equipment include: imaging wear, corrosion, and/or erosion, particularly in subsea pipes, elbows, or connections; identifying stuck or inoperable valves, or obstructions in other subsea equipment; monitoring marine growth and/or fouling of equipment surfaces.

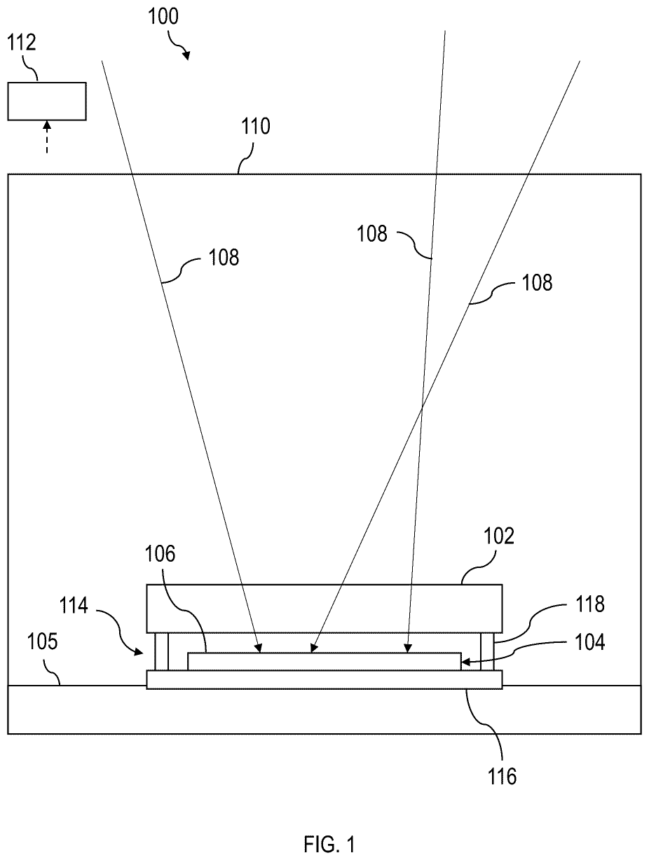

Turning now to the drawings, FIG. 1 illustrates an example system 100 for monitoring subsea equipment using muon imaging. The system 100 includes a subsea equipment component 102 positioned in a subsea environment and a muon detector 104 positioned subsea at a location adjacent the subsea equipment component 102. The term “adjacent” as used throughout this disclosure refers to at least a part of the muon detector being positioned less than 10 meters from the subsea equipment component 102, or more specifically less than 5 meters from the subsea equipment component 102, or more specifically less than 2 meters from the subsea equipment component 102, or more specifically less than 1 meter from the subsea equipment component 102. The muon detector 104 is in a position relative to the subsea equipment component 102 such that muons 108 will pass through the muon detector 104 after passing through the subsea equipment component 102. For example, the muon detector 104 may be positioned adjacent to the subsea equipment component 102 in any direction that is not directly above the subsea equipment component 102, so that muons 108 can pass through the subsea equipment component 102 before reaching the muon detector 104. At least a portion of the muon detector 104 may be located at a vertically lower position than at least a portion of the subsea equipment component 102. For example, the muon detector 104 may be disposed directly beneath the subsea equipment component 102. In other embodiments, the muon detector 104 may be located only partially beneath the subsea equipment component 102, below and off to the side of the subsea equipment component 102, or in some cases even alongside the subsea equipment component 102 (such that only muons 108 passing through the subsea equipment component 102 at an obtuse angle will hit the muon detector 104). In the illustrated embodiment, the muon detector 104 is positioned on an opposite side of the subsea equipment component 102 from the sky so as to maximize the collection of muons 108. The subsea equipment component 102 may include any piece of subsea equipment configured to perform any function in the subsea environment. For example, the subsea equipment may include a subsea pump, a subsea conduit, a subsea valve, a subsea structural component, or a combination thereof. The system 100 may include multiple subsea equipment components 102 located adjacent the muon detector 104, and the system 100 may be used to monitor the multiple subsea equipment components 102 using the same muon detector 104. The subsea equipment component(s) 102 may be in a subsea location proximate to the seafloor 105, as shown. The subsea equipment component(s) 102 may be located at a depth of less than approximately 5 km subsea. The subsea equipment may be free-floating or fixed (e.g., to the seafloor 105).

The muon detector 104 may generally include at least one detector panel 106. The detector panel 106 or combination of multiple detector panels 106 may be approximately the same area as an area of the subsea equipment component 102 to be imaged. The muon detector 104 is configured to output electrical signals indicative of muon intensity in response to muons 108 interacting with the at least one detector panel 106. As illustrated, naturally occurring muons 108 can pass from the Earth's atmosphere through the seawater surface 110, through the seawater and the subsea equipment component 102 before hitting the detector panel 106 of the subsea muon detector 104. The subsea muon detector 104 is configured to detect muons incident on the detector panel(s) 106 and output electrical signals indicative of the detected muon intensity and location of incidence on the panel(s) 106.

In an embodiment, the muon detector 104 may include a scintillator detector. A scintillator detector uses scintillating material that emits light when struck by muons. This light is then captured by photomultiplier tubes or silicon photomultipliers, which convert the light into electrical signals for analysis. In another embodiment, the muon detector 104 may include a gas ionization detector. A gas ionization detector uses one or more chambers filled with gas, typically argon or xenon. When muons pass through the chamber, they ionize the gas, creating electron-ion pairs that are then collected by electrodes, generating electrical signals for analysis. In both types of detectors, the detector is used to measure the properties and trajectories of muons. The muon detector 104 may be disposed in a pressurized enclosure to enable use of the muon detector 104 subsea.

The muon detector 104 may be used for radiographic imaging of the subsea equipment component 102. In the case of radiography, only a single muon detector 104 is needed. The muon detector 104 may function like an X-ray detector but with longer exposure times needed for the diffuse muons to hit the detector panel(s) 106 before enough data is collected to generate a useful image. The muon detector 104 can be used to track variations in density of the objects/materials (e.g., subsea equipment component 102) located adjacent the muon detector 104. The more dense the material located adjacent the muon detector 104, the more muon intensity is absorbed by these materials as the muons 108 pass through, and the lower the intensity of the muons 108 are on the detector panel(s) 106.

The system 100 also includes a data processing system 112 configured to receive data indicative of the electrical signals output from the muon detector 104 and to generate an image of the subsea equipment component 102 based on the received data. When one muon detector 104 is used, as shown in FIG. 1, the images generated by the data processing system 112 may be 2D images. The data processing system 112 may include an algorithm (which may use machine learning) to convert muon intensity on the detector panel(s) 106 and location of muon incidence on the detector panel(s) 106 over time to a viewable 2D image. The data processing system 112 may use well known radiographic imaging techniques to generate the viewable 2D image of the subsea equipment component 102 based on the signals received from the muon detector 104. Although the data processing system 112 is shown located above the sea surface 110, in other embodiments the data processing system 112 may be located partially or fully at a subsea location. The data processing system 112 may be separate from and communicatively coupled to the muon detector 104, or may be partially or fully integrated into the muon detector 104.

The muon detector 104 may output electrical signals in real time or after a delay. It takes several minutes to days to obtain enough muon detection data to generate a meaningful image of the subsea equipment component 102. As such, the communication rate required to send muon detection data and/or images to the surface is low. This enables the use of many potential subsea communication protocols, including those with low bandwidth (e.g., low frequency sound transmission). In some embodiments, the muon detector 104 may utilize local data storage with batch communication to a passing remote operated vehicle (ROV) or autonomous underwater vehicle (AUV). Other communication protocols are possible as well.

The data processing system 112 may generate multiple images of the subsea equipment component 102 based on the received muon detection data over time. Monitoring the images over time to see how they change can provide insight into the health and operations of subsea equipment. The data processing system 112 may display the images generated by muon radiography to a user for determination of whether an issue exists or is approaching. In some embodiments, the data processing system 112 itself may analyze and compare the images taken over the life of the subsea equipment and output an alert when the changes in images indicate an issue (e.g., stuck valve, deposition in a conduit, undesired marine growth, etc.).

As illustrated, the muon detector 104 and the subsea equipment component 102 may be coupled to each other in a fixed relationship via one or more structural components 114. This maintains the muon detector 104 in a fixed position relative to the subsea equipment component 102, thereby enabling the system 100 to provide accurate monitoring of radiographic images of the subsea equipment component 102 over time. In some embodiments, the muon detector 104 may be incorporated into the structure of the subsea equipment component 102 at the time of construction and deployment of the subsea equipment. For example, as illustrated, the muon detector 104 may be built onto a mud mat 116 or other seafloor structural component of the subsea equipment, and the subsea equipment component 102 may be connected to the mud mat 116 via upwardly extending structures 118 to hold the subsea equipment component 102 above the mud mat 116 and the muon detector 104.

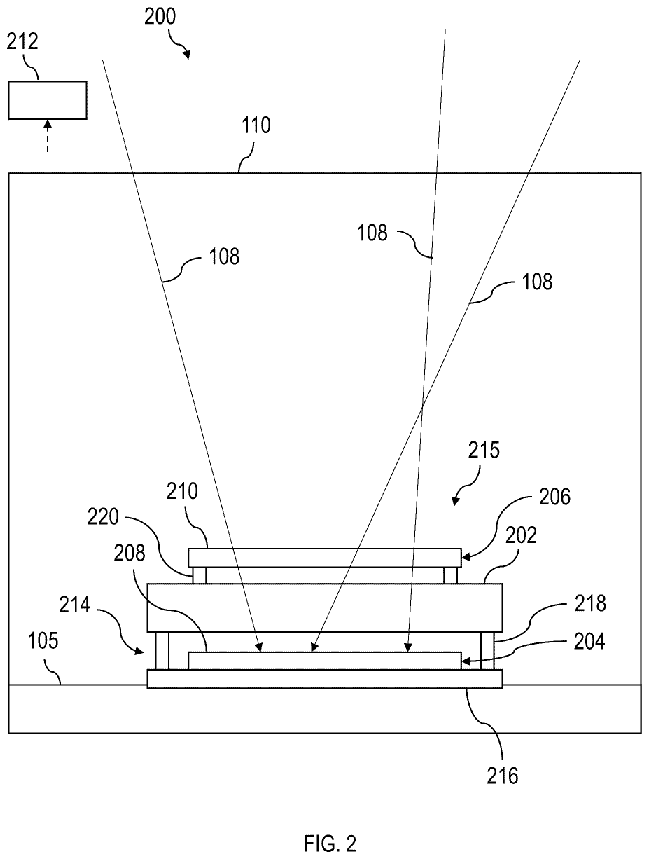

FIG. 2 illustrates another example system 200 for monitoring subsea equipment using muon imaging. The system 200 includes a subsea equipment component 202 positioned in a subsea environment, a first muon detector 204 positioned subsea at a location adjacent the subsea equipment component 202. The first muon detector 204 is in a position relative to the subsea equipment component 202 such that muons 108 will pass through the first muon detector 204 after passing through the subsea equipment component 202. For example, the first muon detector 204 may be positioned adjacent to the subsea equipment component 202 in any direction that is not directly above the subsea equipment component 202, so that muons 108 can pass through the subsea equipment component 202 before reaching the first muon detector 204. At least a portion of the first muon detector 204 may be located at a vertically lower position than at least a portion of the subsea equipment component 202. For example, the first muon detector 204 may be disposed directly beneath the subsea equipment component 202. In other embodiments, the first muon detector 204 may be located only partially beneath the subsea equipment component 202, below and off to the side from the subsea equipment component 202, or in some cases even alongside the subsea equipment component 202 (such that only muons 108 passing through the subsea equipment component 202 at an obtuse angle will hit the first muon detector 204). In the illustrated embodiment, the first muon detector 204 is positioned on an opposite side of the subsea equipment component 202 from the sky so as to maximize the collection of muons that have passed through the subsea equipment.

The system 200 also includes a second muon detector 206 positioned at a location relative to the subsea equipment component 202 such that muons 108 will pass through the second muon detector 206 before passing through the subsea equipment component 202. For example, the second muon detector 206 may be positioned relative to the subsea equipment component 202 in any direction that is not directly below the subsea equipment component 202, so that muons 108 can pass through the second muon detector 206 before reaching the subsea equipment component 202. At least a portion of the second muon detector 206 may be located at a vertically higher position than at least a portion of the subsea equipment component 202. For example, the second muon detector 206 may be disposed directly above the subsea equipment component 202. In other embodiments, the second muon detector 206 may be located only partially above the subsea equipment component 202, above and off to the side of the subsea equipment component 202, or in some cases even alongside the subsea equipment component 202 (such that only muons 108 passing through the second muon detector 206 at an obtuse angle will hit the subsea equipment component 202). In the illustrated embodiment, the second muon detector 206 is positioned on the same side of the subsea equipment component 202 as the sky (between the equipment and the sky) so as to maximize the collection of muons that will then pass through the subsea equipment component 202.

The subsea equipment component 202 of FIG. 2 is similar in structure and function to the subsea equipment component 102 described above with reference to FIG. 1, and the description of the subsea equipment component will not be repeated here. The system 200 may include multiple subsea equipment components 202 located adjacent the first muon detector 204 and/or the second muon detector 206, and the system 200 may be used to monitor the subsea equipment component(s) 202 using the same muon detectors 204, 206.

Like the muon detector 104 described above with respect to FIG. 1, each of the muon detectors 204, 206 in FIG. 2 may generally include at least one detector panel 208, 210, respectively. The detector panel 208, 210 or combination of multiple detector panels for a given muon detector 204, 206 may be approximately the same area as an area of the subsea equipment component 202 to be imaged. The first muon detector 204 is configured to output electrical signals indicative of muon intensity in response to muons 108 interacting with the at least one detector panel 208. The second muon detector 206 is configured to output electrical signals indicative of muon intensity in response to muons 108 interacting with the at least one detector panel 210. As illustrated, naturally occurring muons 108 can pass from the Earth's atmosphere through the seawater surface 110 and through the seawater before hitting the detector panel 210 of the second muon detector 206, and then through the subsea equipment component 202 before hitting the detector panel 208 of the first muon detector 204. Each subsea muon detector 204, 206 is configured to detect muons incident on the respective detector panel(s) 208, 210 and output electrical signals indicative of the detected muon intensity and location of incidence on the panel(s). The muon detectors 204, 206 may include scintillator detectors, gas ionization detectors, or one of each. Each muon detector 204, 206 may be disposed in a pressurized enclosure to enable use of the muon detectors 204, 206 subsea.

The first and second muon detectors 204, 206 may be used for tomographic imaging of the subsea equipment component 202. In the case of tomography, at least two muon detectors 204, 206 are needed. Since muons 108 come in from the atmosphere at varying angles, an understanding of the location and muon intensity where a muon 108 interacts with each detector 204, 206 can be used to form a 3D image of the subsea equipment component 202. The muon detectors 204, 206 may function like CT scanners but with longer exposure times for the diffuse muons to hit the detector panels 208, 210 before enough data is collected to generate a useful 3D image, and without moving the detector panels. The atmosphere provides a diffuse source of muons 108, so there is no need to move the muon detectors 204, 206 to generate the 3D image. The muon detectors 204, 206 can be used to track variations in density of the objects/materials (e.g., subsea equipment component 202) in three dimensional space located between the muon detectors 204, 206. The more dense the material of the subsea equipment located between the muon detectors 204, 206, the more muon intensity is absorbed by these materials as the muons 108 pass between the two detectors 204, 206, and the greater the difference in muon intensity measured by the detector panels 208, 210.

The system 200 also includes a data processing system 212 configured to receive data indicative of the electrical signals output from both the first muon detector 204 and the second muon detector 206 and to generate a 3D image of the subsea equipment component 202 based on the received data. The data processing system 212 may include an algorithm (which may use machine learning) to convert muon intensity on the detector panels 208, 210 and location of muon incidence on the detector panels 208, 210 over time to a viewable 3D image. In particular, the data processing system 212 may correlate muon arrivals at the first and second detectors 204, 206 to calculate changes in energy intensity and angle (indicating the direction the muon 108 is traveling). The data processing system 212 may use well known tomographic imaging techniques to generate the viewable 3D image of the subsea equipment component 202 based on the signals received from the muon detectors 204, 206.

Although the data processing system 212 is shown located above the sea surface 110, in other embodiments the data processing system 212 may be located partially or fully at a subsea location. The data processing system 212 may be separate from and communicatively coupled to the muon detectors 204, 206, or may be partially or fully integrated into one or both muon detectors 204, 206.

The muon detectors 204, 206 may output electrical signals in real time or after a delay. It takes several minutes to days to obtain enough muon detection data to generate a meaningful image of the subsea equipment component 202. As such, the communication rate required to send muon detection data and/or images to the surface is low. This enables the use of many potential subsea communication protocols, including those with low bandwidth (e.g., low frequency sound transmission). In some embodiments, the muon detector 204, 206 may utilize local data storage with batch communication to a passing remote operated vehicle (ROV) or autonomous underwater vehicle (AUV). Other communication protocols are possible as well.

The data processing system 212 may generate multiple 3D images of the subsea equipment component 202 based on the received muon detection data over time and based on a known fixed relationship between the first muon detector and the second muon detector. Monitoring the images over time to see how they change can provide insight into the health and operations of subsea equipment. The data processing system 212 may display the images generated by muon tomography to a user for determination of whether an issue exists or is approaching. In some embodiments, the data processing system 212 itself may analyze and compare the images taken over the life of the subsea equipment and output an alert when the changes in images indicate an issue (e.g., stuck valve, deposition in a conduit, undesired marine growth, etc.).

As illustrated, the muon detectors 204, 206 and the subsea equipment component 202 may be coupled to each other in a known fixed relationship via one or more structural components 214. This maintains both muon detectors 204, 206 in a fixed position relative each other and to the subsea equipment component 202, thereby enabling the system 200 to provide accurate monitoring of tomographic images of the subsea equipment component 202 over time. In some embodiments, the muon detectors 204, 206 may be integrated with the subsea equipment component 202 in a subsea equipment package 215 at the time of construction and deployment of the subsea equipment. For example, as illustrated, the first muon detector 204 may be built onto a mud mat 216 or other seafloor structural component of the subsea equipment. The subsea equipment component 202 may be connected to the mud mat 216 via upwardly extending structures 218 to hold the subsea equipment 202 above the mud mat 216 and the first muon detector 204. The second muon detector 206 may be connected to the subsea equipment via upwardly extending structures 220 to hold the second muon detector 206 adjacent the subsea equipment component 202.

Although the second muon detector 206 is shown as being directly vertically aligned with the first muon detector 204, such alignment is not required. However, the relative position of the second detector 206 and the first detector 204 to each other and to the subsea equipment component 202 should be known at each point in time. The data processing system 212 is configured to generate the 3D image based on the received data and based on the known fixed relationship between the first muon detector 204 and the second muon detector 206.

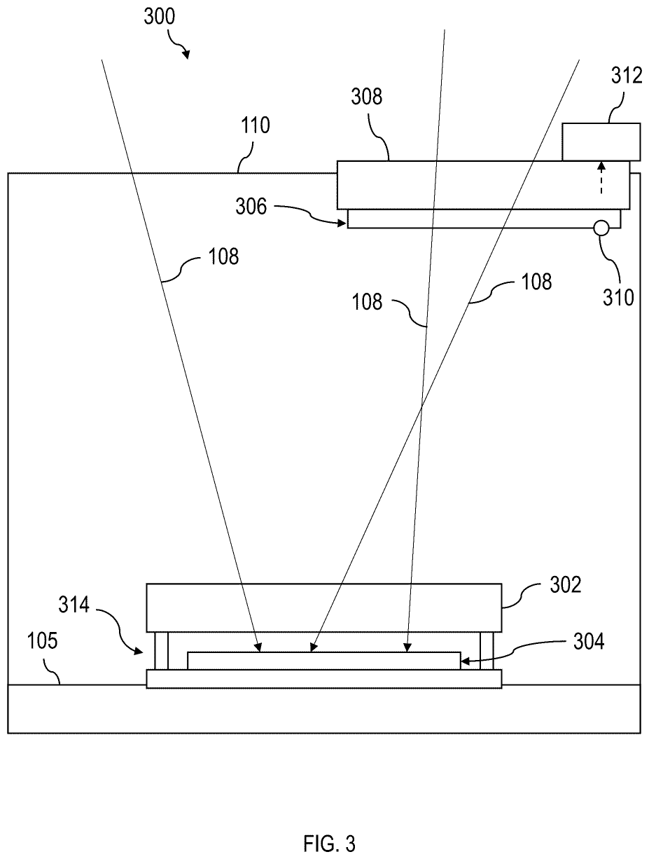

In other embodiments, such as shown in FIG. 3, the two detectors need not be fixed relative to each other. FIG. 3 illustrates an example system 300 for monitoring subsea equipment using muon imaging. The system 300 includes a subsea equipment component 302 positioned in a subsea environment, a first muon detector 304 positioned subsea at a location adjacent the subsea equipment component 302. The first muon detector 304 is in a position relative to the subsea equipment component 302 such that muons 108 will pass through the first muon detector 304 after passing through the subsea equipment component 302. For example, the first muon detector 304 may be positioned adjacent to the subsea equipment component 302 in any direction that is not directly above the subsea equipment component 302, so that muons 108 can pass through the subsea equipment component 302 before reaching the first muon detector 304. At least a portion of the first muon detector 304 may be located at a vertically lower position than at least a portion of the subsea equipment component 302. For example, the first muon detector 304 may be disposed directly beneath the subsea equipment component 302. In other embodiments, the first muon detector 304 may be located only partially beneath the subsea equipment component 302, beneath and off to the side of the subsea equipment component 302, or in some cases even alongside the subsea equipment component 302 (such that only muons 108 passing through the subsea equipment component 302 at an obtuse angle will hit the first muon detector 304). In the illustrated embodiment, the first muon detector 304 is positioned on an opposite side of the subsea equipment component 302 from the sky so as to maximize the collection of muons that have passed through the subsea equipment.

The system 300 also includes a second muon detector 306 positioned at a location relative to the subsea equipment component 302 such that muons 108 will pass through the second muon detector 306 before passing through the subsea equipment component 302. For example, the second muon detector 306 may be positioned relative to the subsea equipment component 302 in any direction that is not directly below the subsea equipment component 302, so that muons 108 can pass through the second muon detector 306 before reaching the subsea equipment component 302. At least a portion of the second muon detector 306 may be located at a vertically higher position than at least a portion of the subsea equipment component 302. For example, the second muon detector 306 may be disposed directly above the subsea equipment component 302. As shown in FIG. 3, the second muon detector 306 may be disposed above and off to one side relative to the subsea equipment component 302. In other embodiments, the second muon detector 306 may be located only partially above the subsea equipment component 302, or in some cases even alongside the subsea equipment component 302 (such that only muons 108 passing through the second muon detector 306 at an obtuse angle will hit the subsea equipment component 302). In the illustrated embodiment, the second muon detector 306 is positioned on the same side of the subsea equipment component 302 as the sky (between the equipment and the sky) so as to maximize the collection of muons that will then pass through the subsea equipment component 302.

The subsea equipment component 302 of FIG. 3 is similar in structure and function to the subsea equipment components 102, 202 described above with reference to FIGS. 1 and 2, and the description of the subsea equipment component will not be repeated here. The first and second muon detectors 304, 306 of FIG. 3 are similar in structure and function to the first and second muon detectors 204, 206 described above with reference to FIG. 2, and the description of the detectors will not be repeated here. As shown in FIG. 3, the second muon detector 306 may be substantially free floating, able to move relative to the first muon detector 304 and/or the subsea equipment component 302. For example, the second muon detector 306 may be coupled to a floating structure 308 (e.g., at the bottom of a ship or floating platform). The system 300 further includes one or more sensors 310 configured to measure a change in relative position (e.g., movements along x-y-z axes and rotations around x-y-z axes) of the second muon detector 306 with respect to the first muon detector 304. As illustrated, the sensor(s) 310 may be coupled to the second muon detector 306 and configured to measure a position and angle of the second muon detector 306. The sensor(s) 310 may include, for example, an accelerometer, a gyroscope, multiple position sensors, etc.

As illustrated, the second muon detector 306 may be positioned proximate a surface level 110 of the sea and movable, while the first muon detector 304 is located near the seafloor 105 and is fixed. In other embodiments, the first muon detector 304 may be located subsea and movable (with one or more sensors 310 coupled thereto), while the second muon detector 306 may be located near the sea surface 110 and fixed. In still other embodiments, both muon detectors 304, 306 may be movable as long as the system 300 includes sensors 310 configured to measure the change in relative position/angle of the muon detectors with respect to one another and with respect to the subsea equipment component 302 over time.

The first and second muon detectors 304, 306 and sensor(s) 310 may be used for tomographic imaging of the subsea equipment component 302. Since muons 108 come in from the atmosphere at varying angles, an understanding of the location and muon intensity where a muon 108 interacts with each detector 304, 306, along with the relative position/angle of the detectors 304, 306 to each other, can be used to form a 3D image of the subsea equipment component 302. The muon detectors 304, 306 may function like CT scanners but with longer exposure times for the diffuse muons to hit the detector panels 208, 210 before enough data is collected to generate a useful 3D image. The atmosphere provides a diffuse source of muons 108, so there is no need to move the muon detectors 304, 306 to generate the 3D image. The muon detectors 304, 306 can be used to track variations in density of the objects/materials (e.g., subsea equipment component 302) in three dimensional space located between the muon detectors 304, 306. The more dense the material of the subsea equipment located between the muon detectors 304, 306, the more muon intensity is absorbed by these materials as the muons 108 pass between the two detectors 304, 306, and the greater the difference in muon intensity measured by the detector panels.

The system 300 also includes a data processing system 312 configured to receive data indicative of the electrical signals output from both the first muon detector 304 and the second muon detector 306, along with measurements from the one or more sensors 310, and to generate a 3D image of the subsea equipment component 302 based on the received data and sensor measurements. The data processing system 312 may include an algorithm (which may use machine learning) to convert muon intensity on the detector panels, location of muon incidence on the detector panels, and changes in the position/angle of the detector panels relative to each other over time to a viewable 3D image. In particular, the data processing system 312 may correlate muon arrivals at the first and second detectors 304, 306 and calibrate these arrivals based on the relative positions/angles of the detectors 304, 306 to calculate changes in energy intensity and angle (indicating the direction the muon 108 is traveling). The data processing system 312 may use well known tomographic imaging techniques to generate the viewable 3D image of the subsea equipment component 302 based on the signals received from the muon detectors 304, 306 and the data received from the sensor(s) 310.

Although the data processing system 312 is shown located above the sea surface 110 (e.g., on the floating structure 308), in other embodiments the data processing system 312 may be located partially or fully at a subsea location. The data processing system 312 may be separate from and communicatively coupled to the muon detectors 304, 306, or may be partially or fully integrated into one or both muon detectors 304, 306.

The muon detectors 304, 306 may output electrical signals in real time or after a delay. It takes several minutes to days to obtain enough muon detection data to generate a meaningful image of the subsea equipment component 302. As such, the communication rate required to send muon detection data and/or images to the surface is low. This enables the use of many potential subsea communication protocols, including those with low bandwidth (e.g., low frequency sound transmission). In some embodiments, one or both muon detectors 304, 306 may utilize local data storage with batch communication to a passing remote operated vehicle (ROV) or autonomous underwater vehicle (AUV). Other communication protocols are possible as well.

The data processing system 312 may generate multiple 3D images of the subsea equipment component 302 based on the received muon detection data and position data from sensor(s) 310 over time. Monitoring the images over time to see how they change can provide insight into the health and operations of subsea equipment. The data processing system 312 may display the images generated by muon tomography to a user for determination of whether an issue exists or is approaching. In some embodiments, the data processing system 312 itself may analyze and compare the images taken over the life of the subsea equipment and output an alert when the changes in images indicate an issue (e.g., stuck valve, deposition in a conduit, undesired marine growth, etc.).

As illustrated, the first muon detectors 304 and the subsea equipment component 302 may be coupled to each other in a fixed relationship via one or more structural components 314, while the second muon detector 306 is separate from these components. As long as the movement between the second muon detector 306 and the first muon detector 304 are known (e.g., based on the sensor measurements), the system 300 is able to provide accurate monitoring of tomographic images of the subsea equipment component 302 over time. As shown, the second muon detector 306 need not be directly vertically aligned with the first muon detector 304 and/or subsea equipment component 302. However, the relative position of the second detector 306 and the first detector 304 to each other and to the subsea equipment component 302 should be known at each point in time.

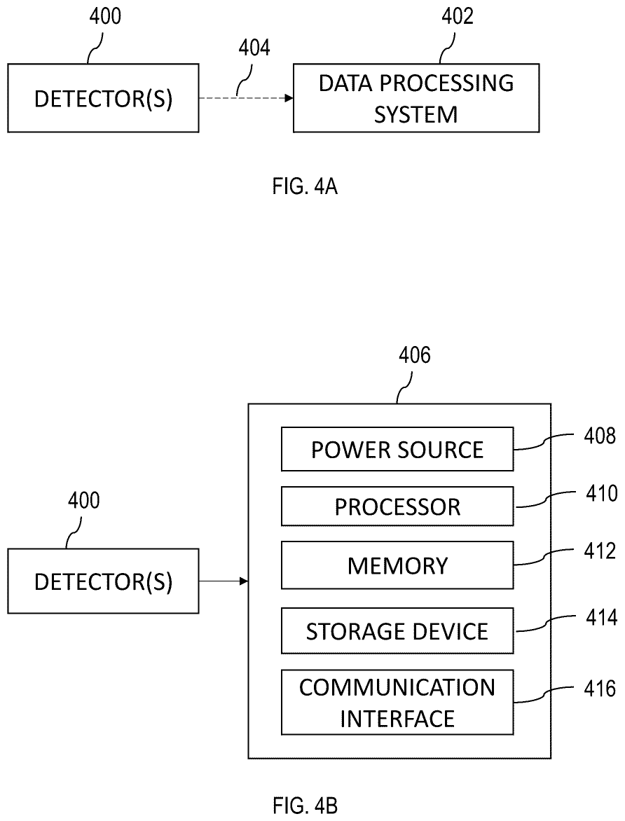

FIGS. 4A and 4B are block diagrams illustrating example muon imaging assemblies with different communication layouts for transferring muon detector information from one or more subsea muon detectors 400 (e.g., detectors 104, 204, 206, 304, 306 of FIGS. 1-3) to a data processing system 402 (e.g., data processing systems 112, 212, 312 of FIGS. 1-3). The data processing system 402 is configured to receive data indicative of the electrical signals output from the muon detector(s) 400 and generate an image (e.g., 2D image for muon radiography, or 3D image for muon tomography) of the subsea equipment component based on the received data. The data processing system 402 may be located above the sea surface, at a subsea location, or split between subsea and above the sea surface.

As shown in FIG. 4A, in some embodiments the subsea muon detectors 400 are communicatively coupled directly to the data processing system 402. For example, a system (e.g., systems 100, 200, 300 of FIGS. 1-3) may include a communication system 404 at least partially located subsea and configured to communicate the data indicative of the electrical signals output from the muon detector(s) 400 to the data processing system 402. The communication system 404 may be wired or wireless and may utilize any desired communication protocol that is appropriate for subsea use.

As shown in FIG. 4B, in some embodiments a system (e.g., systems 100, 200, 300 of FIGS. 1-3) includes a subsea processing unit 406 located subsea and coupled to the muon detector(s) 400. The subsea processing unit 406 may form part of the data processing system (performing pre-processing of the muon detector data) or may be separate from the data processing system (e.g., 402) that generates an image based on the received muon detector data. The subsea processing unit 406 may include a power source 408 (e.g., battery), a processor 410, a memory 412, a storage device 414, and a communication interface 416. The memory 412 may store instructions that, when executed by the processor 410, cause the processor 410 to perform one or more actions such as changing the form of the muon detector data and/or storing the muon detector data in the onboard storage device 414. The communication interface 416 may be configured to communicate the data (indicative of the electrical signals) stored in the storage device 414 to the data processing system (e.g., 402). The communication interface 416 may be wired or wireless and may utilize any desired communication protocol that is appropriate for subsea use. In some embodiments, the communication interface 416 may be a remote operated vehicle (ROV) or autonomous underwater vehicle (AUV) interface configured to facilitate the retrieval of the data stored in the storage device 414 by an ROV or AUV that can then take the collected data to a data processing system (e.g., 402) above the sea surface.

Other arrangements of communication systems and the data processing system 402 may be used without departing from the scope of the present disclosure. The data indicative of electrical outputs from the subsea muon detectors 400 may be continuously or intermittently communicated to the data processing system 402 over time such that the data processing system 402 is able to generate images of the subsea equipment component(s) to enable monitoring of the subsea equipment component(s) over time.

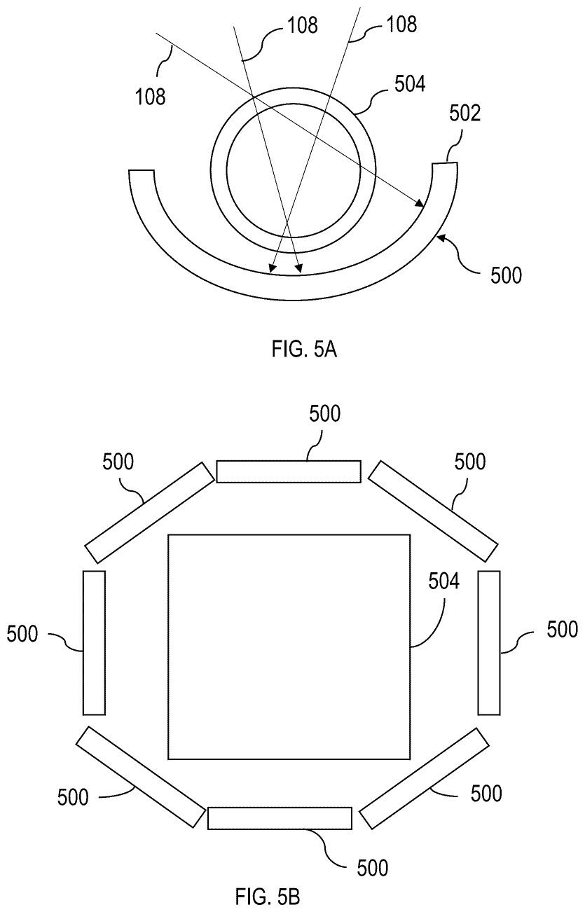

FIGS. 5A and 5B illustrate certain arrangements of subsea muon detector(s) 500 that may be used in the systems described above. FIG. 5A illustrates a single subsea muon detector 500 having a curved detector panel 502. Using a curved detector panel 502 may enable detection of a larger number of muons 108 passing through the subsea equipment component 504 being monitored than a similarly sized flat detector panel. The curved detector panel 502 may curve around an underside of the subsea equipment component 504, as shown. The curved detector panel 502 may be particularly useful for monitoring subsea equipment 504 having a rounded shape or cross section such as, for example, a subsea conduit.

FIG. 5B illustrates an arrangement of multiple subsea muon detectors 500 that are placed at different positions surrounding a subsea equipment component 504. An arrangement of several muon detectors 500, such as shown in FIG. 5B, may be used to perform muon tomography as described above with reference to FIGS. 2 and 3, only with a larger number of detectors 500. Any desired number, arrangement, or shape (e.g., curved or flat) of detectors 500 may be used to perform muon imaging of subsea equipment without departing from the scope of the present disclosure. The muon detectors 500 may be fixed relative to one another and to the subsea equipment component 504, as described with reference to FIG. 2. Alternatively, one or more of the muon detectors 500 may be movable relative to the others and/or the subsea equipment component 504, and in those cases sensor measurements can be taken to correlate their relative positions over time as described with reference to FIG. 3.

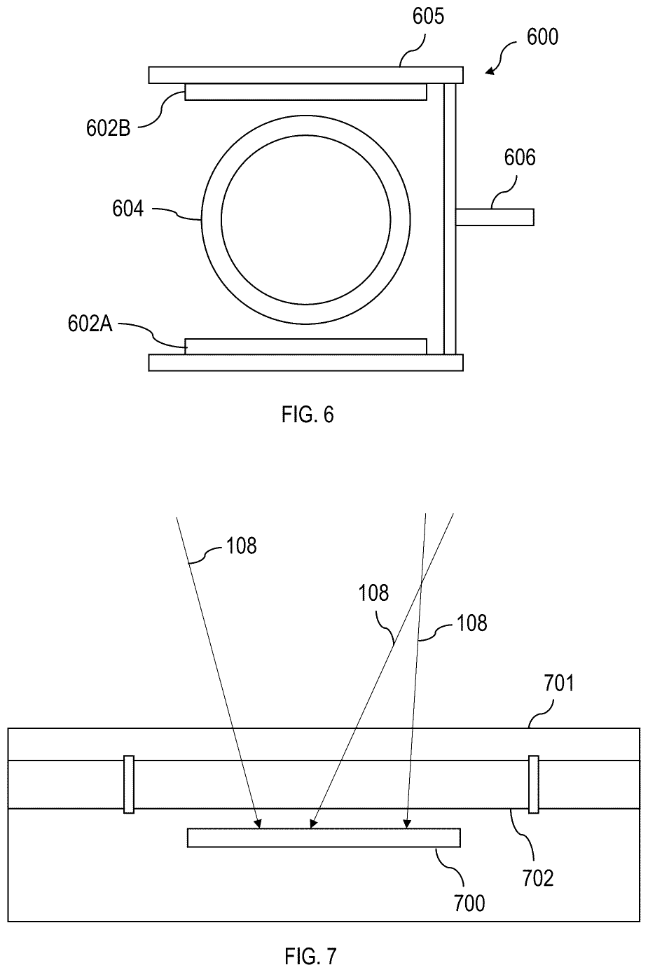

In some embodiments of the systems described above, a first muon detector (104, 204, 304) and/or a second muon detector (206, 306) may be integrated into a clamp system configured to be selectively placed around the subsea equipment component via a remote operated vehicle (ROV) or autonomous underwater vehicle (AUV). FIG. 6 illustrates an example subsea muon detection clamp system 600 having two muon detectors 602 formed thereon. The clamp system 600 can be selectively placed around a subsea equipment component 604 (such as a subsea conduit) so that the muon detectors 602 can be used to collect images of and monitor changes of the subsea equipment component 604 over time. The clamp system 600 may include a clamp frame structure 605 and a handle 606 by which an ROV or AUV can place the clamp system 600 around the subsea equipment component 604. The handle 606 may be coupled to the clamp frame structure 605 and configured to be engaged by a remote operated vehicle (ROV) or autonomous underwater vehicle (AUV) for selective placement of the clamp system 600 relative to the subsea equipment component 604 at a subsea location. The clamp system 600 may include a first detector 602A positioned on a first surface of the clamp frame structure 605 configured to be placed substantially beneath the subsea equipment component 604. In addition, the clamp system 600 may include a second detector 602B positioned on a second surface of the clamp frame structure 605 configured to be placed substantially above the subsea equipment component 604. The clamp system 600 may be used to retrofit existing subsea equipment with muon detectors 602 to provide muon tomographic imaging of the subsea equipment component 604. A similar clamp system may be used with just a single muon detector 602 (i.e., 602A) on its lower side to provide muon radiographic imaging of the subsea equipment component 604 through a retrofit solution.

As shown in FIG. 7, similar arrangements of muon detector(s) 700 may be used to monitor buried equipment that is located below the surface 701 of earth. FIG. 7 shows an example of a muon radiographic imaging system using a muon detector 700 located vertically below a buried pipeline 702. In other embodiments, the system may include multiple muon detectors 700 located adjacent (e.g., both below and above) the buried pipeline 702. The muon detectors 700 may be placed relative to the buried pipeline 702 at the time of initial construction of the pipeline 702. In addition to subsea and subsurface uses, the disclosed muon detector systems may be used to monitor equipment that is submerged in fluids other than water (e.g., equipment located in tanks). As long as a muon detector can be placed adjacent the equipment such that muons will pass through the muon detector after passing through the equipment, the disclosed systems and methods can be applied in a variety of environments for monitoring hard to access equipment.

The disclosed techniques enable monitoring of equipment that is not readily accessible for inspection (e.g., subsea, buried underground, or inside a tank of fluid) using muon imaging. The monitoring of such equipment can be performed over long periods of time to track gradual changes in the equipment while the equipment remains in use (i.e., no shutdown is required). Because muons are naturally available, the disclosed techniques are relatively low cost and can run for many weeks, months, or years with low power requirements.

Illustrative Embodiments of the present disclosure may include the following:

Embodiment 1: A system, including: a subsea equipment component positioned in a subsea environment; a first muon detector positioned subsea at a location adjacent the subsea equipment component in a position such that muons will pass through the first muon detector after passing through the subsea equipment component, wherein the first muon detector includes at least one detector panel and is configured to output electrical signals indicative of muon intensity in response to muons interacting with the at least one detector panel; and a data processing system configured to receive data indicative of the electrical signals output from the first muon detector and generate an image of the subsea equipment component based on the received data.

Embodiment 2: The system of Embodiment 1, wherein the first muon detector is a scintillator detector or a gas ionization detector.

Embodiment 3: The system of Embodiment 1, wherein the subsea equipment component is a subsea pump, a subsea conduit, a subsea valve, a subsea structural component, one or more metallic components of subsea equipment, or a combination thereof.

Embodiment 4: The system of Embodiment 1, wherein at least a portion of the first muon detector is located at a vertically lower position than at least a portion of the subsea equipment component.

Embodiment 5: The system of Embodiment 4, wherein the first muon detector is disposed directly beneath the subsea equipment component.

Embodiment 6: The system of Embodiment 1, wherein the first muon detector and the subsea equipment component are coupled to each other in a fixed relationship via one or more structural components.

Embodiment 7: The system of Embodiment 1, wherein the data processing system is configured to generate a 2D image of the subsea equipment component.

Embodiment 8: The system of Embodiment 1, further including: a second muon detector positioned at a location relative to the subsea equipment component such that muons will pass through the second muon detector before passing through the subsea equipment component, wherein the second muon detector includes at least one detector panel and is configured to output electrical signals indicative of muon intensity in response to muons interacting with the at least one detector panel; wherein the data processing system is configured to receive data indicative of the electrical signals output from the second muon detector and generate a 3D image of the subsea equipment component based on the received data.

Embodiment 9: The system of Embodiment 8, wherein at least a portion of the second muon detector is located at a vertically higher position than at least a portion of the subsea equipment component.

Embodiment 10: The system of Embodiment 9, wherein the second muon detector is disposed directly above the subsea equipment component.

Embodiment 11: The system of Embodiment 8, wherein the first muon detector and the second muon detector are coupled to each other in a known relationship via one or more structural components, wherein the data processing system is configured to generate the 3D image based on the received data and based on the known relationship between the first muon detector and the second muon detector.

Embodiment 12: The system of Embodiment 8, wherein the first muon detector and the second muon detector are integrated with the subsea equipment component in a subsea equipment package.

Embodiment 13: The system of Embodiment 8, wherein the second muon detector is positioned proximate a surface level of the sea.

Embodiment 14: The system of Embodiment 8, further including one or more sensors coupled to the second muon detector and configured to measure a position and angle of the second muon detector, wherein the one or more sensors are communicatively coupled to the data processing system, wherein the data processing system is configured to generate the 3D image based on the data received from the muon detectors and data received from the one or more sensors.

Embodiment 15: The system of Embodiment 1, further including a communication system at least partially located subsea and configured to communicate data indicative of the electrical signals output from the first muon detector to the data processing system.

Embodiment 16: The system of Embodiment 1, further including a storage device located subsea and configured to store data indicative of the electrical signals output from the first muon detector for retrieval by a remote operated vehicle (ROV) or autonomous underwater vehicle (AUV).

Embodiment 17: The system of Embodiment 1, wherein the first muon detector and the second muon detector are integrated into a clamp system configured to be selectively placed around the subsea equipment component via a remote operated vehicle (ROV) or autonomous underwater vehicle (AUV).

Embodiment 18: A method, including: using a first muon detector, positioned at a subsea location adjacent to a subsea equipment component in a position such that muons will pass through the first muon detector after passing through the subsea equipment component, to detect muons incident on at least one detector panel of the first muon detector; outputting electrical signals indicative of muon intensity from the first muon detector; receiving data indicative of the electrical signals output from the first muon detector at a data processing system; and generating, via the data processing system, an image of the subsea equipment component based on the received data.

Embodiment 19: The method of Embodiment 18, further including maintaining the first muon detector in a fixed position relative to the subsea equipment component.

Embodiment 20: The method of Embodiment 18, wherein the image is a 2D image.

Embodiment 21: The method of Embodiment 18, further including: using a second muon detector, positioned at a location relative to the subsea equipment component such that muons will pass through the second muon detector before passing through the subsea equipment component, to detect muons incident on at least one detector panel of the second muon detector; outputting electrical signals indicative of muon intensity from the second muon detector; receiving data indicative of the electrical signals output from the second muon detector at the data processing system; and generating, via the data processing system, a 3D image of the subsea equipment component based on the received data.

Embodiment 22: The method of Embodiment 21, further including: measuring, via one or more sensors, a position and angle of the second muon detector with respect to the first muon detector; and receiving measurements from the one or more sensors at the data processing system.

Embodiment 23: The method of Embodiment 18, further including communicating data indicative of the electrical signals output from the first muon detector to the data processing system via a communication system at least partially located subsea.

Embodiment 24: The method of Embodiment 18, further including storing, at a storage device located subsea, data indicative of the electrical signals output from the first muon detector for retrieval by a remote operated vehicle (ROV) or autonomous underwater vehicle (AUV).

Embodiment 25: The method of Embodiment 18, wherein the subsea equipment component is located at a depth of less than 5 km subsea.

Embodiment 26: A subsea muon detection clamp system, including: a clamp frame structure; a handle coupled to the clamp frame structure and configured to be engaged by a remote operated vehicle (ROV) or autonomous underwater vehicle (AUV) for selective placement of the clamp system relative to a subsea equipment component at a subsea location; and a first muon detector positioned on a first surface of the clamp frame structure configured to be placed substantially beneath the subsea equipment component, wherein the first muon detector includes at least one detector panel and is configured to output electrical signals indicative of muon intensity in response to muons interacting with the at least one detector panel.

Embodiment 27: The subsea muon detection clamp system of Embodiment 26, further including a second muon detector positioned on a second surface of the of the clamp frame structure configured to be placed substantially above the subsea equipment component, wherein the first muon detector includes at least one detector panel and is configured to output electrical signals indicative of muon intensity in response to muons interacting with the at least one detector panel.

It will be understood that various modifications may be made to the embodiments disclosed herein. Therefore, the above description should not be construed as limiting, but merely as exemplifications of example embodiments. For example, the functions described above and implemented as the best mode for operating the present invention are for illustration purposes only. Other arrangements and methods may be implemented by those skilled in the art without departing from the scope and spirit of this invention. Moreover, those skilled in the art will envision other modifications within the scope and spirit of the claims appended hereto.

What is claimed is:

1. A system, comprising:
a subsea equipment component positioned in a subsea environment;
a first muon detector positioned subsea at a location adjacent the subsea equipment component in a position such that muons will pass through the first muon detector after passing through the subsea equipment component, wherein the first muon detector comprises at least one detector panel and is configured to output electrical signals indicative of muon intensity in response to muons interacting with the at least one detector panel; and
a data processing system configured to receive data indicative of the electrical signals output from the first muon detector and generate an image of the subsea equipment component based on the received data.

2. The system of claim 1, wherein the first muon detector is a scintillator detector or a gas ionization detector.

3. The system of claim 1, wherein the subsea equipment component is a subsea pump, a subsea conduit, a subsea valve, a subsea structural component, or a combination thereof.

4. The system of claim 1, wherein at least a portion of the first muon detector is located at a vertically lower position than at least a portion of the subsea equipment component.

5. The system of claim 4, wherein the first muon detector is disposed directly beneath the subsea equipment component.

6. The system of claim 1, wherein the first muon detector and the subsea equipment component are coupled to each other in a fixed relationship via one or more structural components.

7. The system of claim 1, further comprising:
a second muon detector positioned at a location relative to the subsea equipment component such that muons will pass through the second muon detector before passing through the subsea equipment component, wherein the second muon detector comprises at least one detector panel and is configured to output electrical signals indicative of muon intensity in response to muons interacting with the at least one detector panel;
wherein the data processing system is configured to receive data indicative of the electrical signals output from the second muon detector and generate a 3D image of the subsea equipment component based on the received data.

8. The system of claim 7, wherein the first muon detector and the second muon detector are coupled to each other in a known relationship via one or more structural components, wherein the data processing system is configured to generate the 3D image based on the received data and based on the known relationship between the first muon detector and the second muon detector.

9. The system of claim 7, wherein the first muon detector and the second muon detector are integrated with the subsea equipment component in a subsea equipment package.

10. The system of claim 7, wherein the second muon detector is positioned proximate a surface level of the sea.

11. The system of claim 7, further comprising one or more sensors coupled to the second muon detector and configured to measure a position and angle of the second muon detector, wherein the one or more sensors are communicatively coupled to the data processing system, wherein the data processing system is configured to generate the 3D image based on the data received from the muon detectors and data received from the one or more sensors.

12. The system of claim 1, further comprising a communication system at least partially located subsea and configured to communicate data indicative of the electrical signals output from the first muon detector to the data processing system.

13. The system of claim 1, further comprising a storage device located subsea and configured to store data indicative of the electrical signals output from the first muon detector for retrieval by a remote operated vehicle (ROV) or autonomous underwater vehicle (AUV).

14. The system of claim 1, wherein the first muon detector and the second muon detector are integrated into a clamp system configured to be selectively placed around the subsea equipment component via a remote operated vehicle (ROV) or autonomous underwater vehicle (AUV).

15. A method, comprising:
using a first muon detector, positioned at a subsea location adjacent to a subsea equipment component in a position such that muons will pass through the first muon detector after passing through the subsea equipment component, to detect muons incident on at least one detector panel of the first muon detector;
outputting electrical signals indicative of muon intensity from the first muon detector;
receiving data indicative of the electrical signals output from the first muon detector at a data processing system; and
generating, via the data processing system, an image of the subsea equipment component based on the received data.

16. The method of claim 15, further comprising:
using a second muon detector, positioned at a location relative to the subsea equipment component such that muons will pass through the second muon detector before passing through the subsea equipment component, to detect muons incident on at least one detector panel of the second muon detector;
outputting electrical signals indicative of muon intensity from the second muon detector;
receiving data indicative of the electrical signals output from the second muon detector at the data processing system; and
generating, via the data processing system, a 3D image of the subsea equipment component based on the received data.

17. The method of claim 16, further comprising:
measuring, via one or more sensors, a position and angle of the second muon detector with respect to the first muon detector; and
receiving measurements from the one or more sensors at the data processing system.

18. The method of claim 15, wherein the subsea equipment component is located at a depth of less than 5 km subsea.

19. A subsea muon detection clamp system, comprising:
a clamp frame structure;
a handle coupled to the clamp frame structure and configured to be engaged by a remote operated vehicle (ROV) or autonomous underwater vehicle (AUV) for selective placement of the clamp system relative to a subsea equipment component at a subsea location; and
a first muon detector positioned on a first surface of the clamp frame structure configured to be placed substantially beneath the subsea equipment component, wherein the first muon detector comprises at least one detector panel and is configured to output electrical signals indicative of muon intensity in response to muons interacting with the at least one detector panel.

20. The subsea muon detector clamp system of claim 19, further comprising a second muon detector positioned on a second surface of the of the clamp frame structure configured to be placed substantially above the subsea equipment component, wherein the first muon detector comprises at least one detector panel and is configured to output electrical signals indicative of muon intensity in response to muons interacting with the at least one detector panel.
